(19) United States
(12) Patent Application Publication
(10) Pub. No.: US 2026/0153332 A1
(43) Pub. Date: Jun. 4, 2026

(54) UNMANNED AERIAL VEHICLE-MOUNTED CONTINUOUS VARIABLE-FREQUENCY BLUE-GREEN LASER RADAR FOR WATER DEPTH SURVEY

(71) Applicant: GUILIN UNIVERSITY OF TECHNOLOGY, GUILIN (CN)

(72) Inventors: Jiasheng XU, GUILIN (CN); Guoqing ZHOU, GUILIN (CN); Xiang ZHOU, GUILIN (CN)

(73) Assignee: GUILIN UNIVERSITY OF TECHNOLOGY, GUILIN (CN)

(21) Appl. No.: 19/263,501

(22) Filed: Jul. 9, 2025

(30) Foreign Application Priority Data
Dec. 4, 2024 (CN) 202411773233.5

(51) Int. Cl. G01C 13/00; G01S 17/88

(52) U.S. Cl. CPC G01C 13/008; G01S 17/88

(57) ABSTRACT

The present disclosure is related to an unmanned aerial vehicle-mounted continuous variable-frequency blue-green laser radar for water depth survey, including a blue-green light variable-frequency laser, a laser power supply driver, an encoding motor, a reflective optical wedge, a reflector, a big lens, a small lens, a balanced light detection module, a high-speed laser acquisition processor, an IMU module, an RTK module, a 4G module, a controller, a 4G antenna, a server, a mobile phone terminal and the like according to a characteristic that continuous variable-frequency blue-green laser generates frequency change when encountering a water surface and a water bottom, convolution and fast Fourier transform and a time-frequency correspondence. The laser radar is small in size, light in weight and suitable for an unmanned aerial vehicle to survey a water depth rapidly and precisely, achieves a millimeter-level precision, and realizes 0-10 m water depth survey.

### CROSS-REFERENCE TO RELATED APPLICATION

This application claims the priority benefit of China application serial no. 202411773233.5, filed on December 4, 2024. The entirety of the above-mentioned patent application is hereby incorporated by reference herein and made a part of this specification.

### BACKGROUND

### Technical Field

The present disclosure relates to the technical field of laser probing, and more particularly, to an unmanned aerial vehicle-mounted continuous variable-frequency blue-green laser radar for water depth survey.

### Description of Related Art

At present, dual-frequency (1064 nm and 532 nm) or single-frequency (532 nm) lidar is mostly used as a lidar for water depth survey to detect water depth. A dual-frequency water depth survey lidar in a satellite-borne laser near-coast terrain detection laser radar and detection method (application number: CN202011378792.8) uses time-of-flight ranging, which has the defects serious laser jitter, large error, big volume, heavy weight and high cost, and has to be carried on a helicopter for professional route planning to survey the water depth, resulting in a high cost. Due to the large error, the water depth data obtained by the laser can be used only after being subjected to error processing by using the existing control points.

In addition, patent Rayleigh scattering ocean lidar system (application number: CN201510366352.3) adopts a ranging principle, which is also time-of-flight ranging, and has the defects of unknown laser jitter, and un-published structure of transmitting lens system and big imaging lens, and low ICCD sensitivity. Therefore, it is also impossible to achieve high-precision water depth survey.

A single-frequency water survey laser radar (patent number: ZL202111389861.X) employs a laser with high energy, large repetition rate and narrow pulse width, and a ranging principle of time-of-flight ranging, which is difficult for echo signal processing, has an error within 0.25 m generally, and has a precision too low to meet the requirements of high-precision underwater topographic mapping.

Aiming at the problem of low survey precision of the laser radar caused by adopting time-of-flight ranging above, the present disclosure discloses an unmanned aerial vehicle-mounted continuous variable-frequency blue-green laser radar for water depth survey. The laser radar emits continuous variable-frequency blue-green laser to form a time-frequency diagram, converts frequency information into time information through convolution of a local oscillation laser signal and a laser echo signal and Fourier transform, and is carried on an unmanned aerial vehicle with an altitude of 30-120 m with reference to a propagation speed of light in water, and achieves 0-10 m water depth survey.

### SUMMARY

The present disclosure discloses an unmanned aerial vehicle-mounted continuous variable-frequency blue-green laser radar for water depth survey with a gross weight less than 10 kg, and is suitable for rapidly detecting water depth of 0-10 m, and achieves a millimeter-level precision.

The present disclosure adopts the following technical solution principles:

a blue-green light variable-frequency laser emits two beams of continuous variable-frequency blue-green laser, i.e., an A laser emission signal and a C laser local oscillation signal; and meanwhile, forms a time-frequency diagram by corresponding a frequency domain with a time domain;

one beam of laser is emitted to a water surface and reflected to cause frequency deviation of the laser echo signal, transmits through a water body and reaches a water bottom, and then the laser is reflected again to generate frequency shift to form the B laser echo signal, and the B laser echo signal is collected by a high-speed laser acquisition processor;

the C laser local oscillation signal is directly output to the high-speed laser acquisition processor, and the processor performs convolution operation on the C laser local oscillation signal and the B laser echo signal to obtain a convolution laser echo signal in a spatial domain;

the convolution laser echo signal in the spatial domain is converted into a convolution laser echo signal in a frequency domain through fast Fourier transform, an amplitude-frequency diagram is generated, frequency peaks corresponding to the water surface and the water bottom are identified, and a frequency difference △f is calculated;

a time-frequency difference diagram is generated based on the time-frequency diagram and the amplitude-frequency diagram, the frequency difference △f is converted into a corresponding time difference △t, and a traveled distance of the laser in the water is calculated with reference to a transmission speed of the laser in the water to obtain a surveyed water depth (i.e., water-depth slant distance); and

the water-depth slant distance is converted into an actual water depth of a surveyed position through a rotation matrix according to an encoder angle of a motor, three attitude angles of a POS and positioning information of RTK.

The specific technical solution adopted by the invention is as follows:

The unmanned aerial vehicle-mounted continuous variable-frequency blue-green laser radar for water depth survey mainly comprises components like a blue-green light variable-frequency laser, a laser power supply driver, an encoding motor, a reflective optical wedge, a reflector, a big lens, a small lens, a balanced light detection module, a high-speed laser acquisition processor, an IMU module, an RTK module, a 4G module, a controller, a 4G antenna, a server and a mobile phone terminal.

After receiving a signal sent by a controller, the blue-green light variable-frequency laser emits variable-frequency blue-green laser of 380-600 nm with a peak power of 400 mW, a pulse width of 10 μs, a divergence angle less than 0.2 mrad and a Gaussian distribution from a center to a periphery, and a part of optical signals are separated out of the blue-green light variable-frequency laser by a beam splitter, transmitted to a photomultiplier, and then a local oscillation laser signal is output. Meanwhile, a working state signal is emitted to the controller at a frequency of 30 Hz.

After receiving the signal sent by the controller, the laser power supply driver configures a power supply module according to a parameter of the laser to provide a stable direct-current power supply for the laser with a voltage of 24 V and a current of 150-320 mA. Meanwhile, a working state signal is emitted to the controller at a frequency of 30 Hz.

After receiving an initialization instruction of the controller, the encoding motor immediately returns to zero and calculates a rotation angle of the motor from a fixed position. The encoding motor is equipped with a 1000-wire optical-electricity encoder and a Hall sensor, wherein a voltage is 24 V, a rotating speed is 3,000 r/min, a power is 64 W, a constant torque is 0.2 N·m and an output rotation angle precision is 0.1 degree. A working state signal is emitted to the controller at a frequency of 30 Hz.

The reflector forms an included angle of 45 degrees with the laser, and is made of a base material of silicon with a diameter of 3 mm, a thickness of 3 mm, a surface plated with gold and a reflectivity more than 99.99%. A middle of the reflector is fixed at a center position of the big lens through a triangular disc to reflect the laser beam to the reflective optical wedge.

The reflective optical wedge has a dynamic balance function, a center of the reflective optical wedge forms angles of 30 degrees and 75 degrees with an irradiated laser beam, and an included angle between a reflected laser beam and an upper part changes continuously between 30 degrees and 75 degrees when the reflective optical wedge is mounted on the motor to rotate, thus forming a circular track with a scanning angle of 45 degrees.

The big lens is actually a double-simple lens with positive optical power, a clear aperture of 60 mm, a focal length of 128 mm, and an interval of 106.7 mm from the small lens. The big lens comprises one doublet-cemented lens and one simple lens; the doublet-cemented lens comprises one convex lens and one concave lens; and the simple lens is a convex lens made of ZK7 glass with small dispersion.

The small lens is actually a doublet-cemented lens provided with negative optical power, a clear aperture of 10 mm and a focal length of -35.6 mm. The doublet-cemented lens comprises one flint glass convex lens in the front and one Burmese glass concave lens in the back.

The balanced light detection module has a spectral range of 380-1700 nm, a bandwidth of 3 dB, a response time less than 0.2 ns, a common mode rejection ratio more than 30 dB, and a voltage of 24 V. Meanwhile, data are sent to the high-speed laser acquisition processor at a frequency of 200 Hz and a working state signal is sent to the controller at a frequency of 200 Hz.

The high-speed laser acquisition processor is mainly used to acquire the local oscillation laser signal transmitted by the blue-green light variable-frequency laser and the laser echo signal detected by the balanced light detection module, perform convolution operation and fast Fourier transform on the two signals to obtain an echo frequency difference between the water surface and the water bottom, convert the frequency difference into a corresponding time difference, and obtain the water-depth slant distance with reference to a propagation speed of the laser in the water, substitute the water-depth slant distance into a rotation matrix together with the encoder angle of the motor, three attitude angles of the IMU and positioning information of the RTK, and convert the data into an actual water depth of the surveyed position, and transmit the actual water depth to the controller. Meanwhile, a working state signal is emitted to the controller at a frequency of 30 Hz.

The IMU module is mainly used to acquire a pitching angle, a roll angle and a yaw angle of a carried platform, wherein a resolution is 0.01 degree. Meanwhile, data and a working state signal are sent to the controller at a frequency of 200 Hz.

The RTK module is mainly used to acquire longitude and latitude information, wherein a horizontal precision is better than 0.01 m. Meanwhile, data and a working state signal are sent to the controller at a frequency of 200 Hz.

The 4G module supports dual communication functions of 4G DTU and radio communication (up to 50 km at most), automatically switches to radio communication when there is no 4G signal, sends an instruction forwarded by a server, and sends data and a working state signal back to the server.

The controller is used to initialize and control the blue-green light variable-frequency laser, the laser power supply driver, the high-speed laser acquisition processor, the encoding motor, the balanced light detection module, the IMU module, the RTK module and the 4G module to obtain working states of these modules.

The 4G antenna is used to enhance a 4G signal and a radio signal, so that the signals are enhanced to be more than 3 dB.

The server has a fixed IP address, and both the 4G module and the mobile phone are connected with the server through the IP address, and then the server saves and forwards the data sent by the 4G module and the mobile phone terminal to realize communication between the 4G module and the mobile phone terminal, realize remote control of the unmanned aerial vehicle-mounted continuous variable-frequency blue-green laser radar for water depth survey by the mobile phone, and send back water depth survey data of the unmanned aerial vehicle-mounted continuous variable-frequency blue-green laser radar for water depth survey to the mobile phone in real time.

The mobile phone terminal supports 4G and an external wireless communication module (the wireless communication module is paired with the 4G module of the laser radar in radio communication), and is responsible for connecting the server, and sending an instruction to the unmanned aerial vehicle-mounted continuous variable-frequency blue-green laser radar for water depth survey in real time through the server, wherein water depth survey data of a target position sent back is displayed and saved on the mobile phone.

When the radar is mounted on the unmanned aerial vehicle, a working process of the unmanned aerial vehicle-mounted continuous variable-frequency blue-green laser radar for water depth survey is as follows:

a user starts the unmanned aerial vehicle-mounted continuous variable-frequency blue-green laser radar for water depth survey at the mobile phone terminal, and starts a signal server and the 4G module to send data to the controller, the controller starts all components of the laser radar, and meanwhile, acquires working state signals of all the components, and sends the working state signals back to the mobile phone terminal and display the working state signals; wherein the controller gives start instructions to the blue-green light variable-frequency laser, the laser power supply driver, the high-speed laser acquisition processor, the encoding motor, the balanced light detection module, the IMU module, the RTK module and the 4G module to work, and meanwhile, acquires the working states of the blue-green light variable-frequency laser, the laser power supply driver, the high-speed laser acquisition processor, the encoding motor, the balanced light detection module, the IMU module, the RTK module and the 4G module, and sends the working states back to the mobile phone terminal and displays the working states.

The laser power supply driver supplies power to the blue-green light variable-frequency laser, emits one beam of local oscillation laser signal to the high-speed laser acquisition processor, and also emits one beam of laser to the water surface, and meanwhile, sends the state to the controller.

The encoding motor rotates according to a set parameter, and starts scanning work to acquire as much water domain data as possible, and meanwhile, sends the rotation angle and the working state to the high-speed laser acquisition processor and the controller respectively.

The balanced light detection module detects the laser echo signal received, transmits the laser echo signal to the high-speed laser acquisition processor, and meanwhile, sends the working state signal to the controller.

The IMU module collects the pitching angle, the roll angle and the yaw angle of the platform and sends the angles to the high-speed laser acquisition processor, and meanwhile, sends the working state to the controller.

The RTK module acquires the longitude and latitude information, and sends the information to the high-speed laser acquisition processor, and meanwhile, sends the working state to the controller.

The 4G module is connected with the mobile phone terminal through a 4G signal and the server, and the latter is connected with the mobile phone terminal through a radio signal, sends the instruction forwarded by the server to the unmanned aerial vehicle-mounted continuous variable-frequency blue-green laser radar for water depth survey, and sends back the data and the working state signals to the mobile phone terminal.

The high-speed laser acquisition processor acquires the local oscillation signal and the laser echo signal of the laser, performs convolution, fast Fourier transform, frequency difference and time difference operation, calculates the water-depth slant distance, reads the rotation angle of the motor, the data of the three attitude angles and the positioning data, substitutes the data into the rotation matrix, obtains the actual water depth of the target position, sends the data to the controller, and then sends the data back to the mobile phone for display through the 4G module (and the server), and saves the data to the mobile phone.

Steps (2) to (8) are repeated until all echo signals of water depth in a target area are detected.

The user turns off the unmanned aerial vehicle-mounted continuous variable-frequency blue-green laser radar for water depth survey at the mobile phone terminal, and a turn-off signal is sent to the controller through the 4G module to turn off the blue-green light variable-frequency laser, the laser power supply driver, the high-speed laser acquisition processor, the encoding motor, the balanced light detection module, the IMU module, the RTK module and the 4G module in turn.

Compared with the prior art, the present disclosure has the following advantages.

The blue-green light variable-frequency laser which changes frequency at the water surface and the water bottom is adopted, and the time difference is converted by the convolution and Fourier transform on the local oscillation signal to calculate the water depth.

The blue-green light variable-frequency laser is adopted, which can emit laser beams that change frequency from blue light to green light.

The reflective optical wedge has the dynamic balance function, and the center of the reflective optical wedge forms angles of 30 degrees and 75 degrees with the irradiated laser beam, thus forming a circular track with the scanning angle of 45 degrees.

The big lens is a double-simple lens with the positive optical power. The small lens is a doublet-cemented lens with the negative optical power. The combination of the two can eliminate spherical aberration, coma, astigmatism, curvature of field and distortion, make the laser focus on one point, and increase laser energy and survey depth.

The balanced light detection module has a spectral range of 380-1700 nm, a bandwidth of 3 dB, a response time less than 0.2 ns, and a common mode rejection ratio more than 30 dB.

The high-speed laser acquisition processor is mainly used to acquire the local oscillation laser signal transmitted by the blue-green light variable-frequency laser and the laser echo signal detected by the balanced light detection module, perform convolution operation and fast Fourier transform on the two signals to obtain an echo frequency difference between the water surface and the water bottom, convert the frequency difference into a corresponding time difference, and obtain the water-depth slant distance with reference to a propagation speed of the laser in the water, substitute the water-depth slant distance into a rotation matrix together with an encoder angle of the motor, three attitude angles of the IMU and positioning information of the RTK, and convert the data into an actual water depth of the surveyed position, and transmit the actual water depth to the controller.

The 4G module supports dual automatic switching communication functions of 4G DTU and radio communication (up to 50 km at most).

### BRIEF DESCRIPTION OF THE DRAWINGS

FIG. 1 is a water depth survey principle of the present disclosure; and

FIG. 2 is a schematic diagram of an unmanned aerial vehicle-mounted continuous variable-frequency blue-green laser radar for water depth survey of the present disclosure.

### DESCRIPTION OF THE EMBODIMENTS

In order to make the objects, technical solutions and advantages of the present disclosure more apparent, preferred embodiments are described below, and specific embodiments of the present disclosure are described in further detail with reference to the accompanying drawings.

### Embodiment:

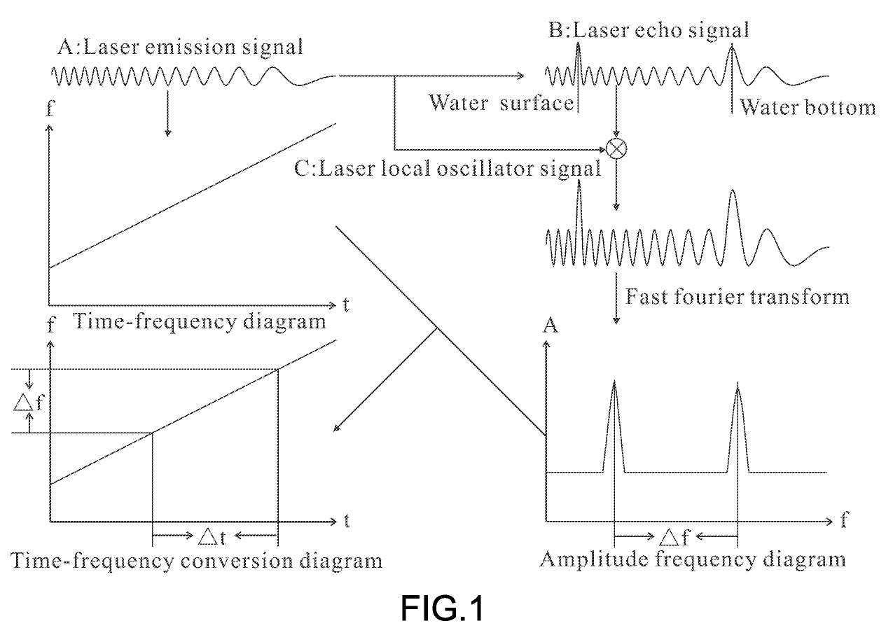

A water depth survey principle of an unmanned aerial vehicle-mounted continuous variable-frequency blue-green laser radar for water depth survey is explained with reference to FIG. 1.

A blue-green light variable-frequency laser emits two beams of continuous variable-frequency blue-green laser, i.e., an A laser emission signal and a C laser local oscillation signal; and meanwhile, forms a time-frequency diagram by corresponding a frequency domain with a time domain;

one beam of laser is emitted to a water surface and reflected to cause frequency deviation of the laser echo signal, transmits through a water body and reaches a water bottom, and then the laser is reflected again to generate frequency shift to form the B laser echo signal, and the B laser echo signal is collected by a high-speed laser acquisition processor;

the C laser local oscillation signal is directly output to the high-speed laser acquisition processor, and the processor performs convolution operation on the C laser local oscillation signal and the B laser echo signal to obtain a convolution laser echo signal in a spatial domain;

the convolution laser echo signal in the spatial domain is converted into a convolution laser echo signal in a frequency domain through fast Fourier transform, an amplitude-frequency diagram is generated, frequency peaks corresponding to the water surface and the water bottom are identified, and a frequency difference △f is calculated;

a time-frequency difference diagram is generated based on the time-frequency diagram and the amplitude-frequency diagram, the frequency difference △f is converted into a corresponding time difference △t, and a traveled distance of the laser in the water is calculated with reference to a transmission speed of the laser in the water to obtain a surveyed water depth (i.e., water-depth slant distance); and

the water-depth slant distance is converted into an actual water depth of a surveyed position through a rotation matrix according to an encoder angle of a motor, three attitude angles of a POS and positioning information of RTK.

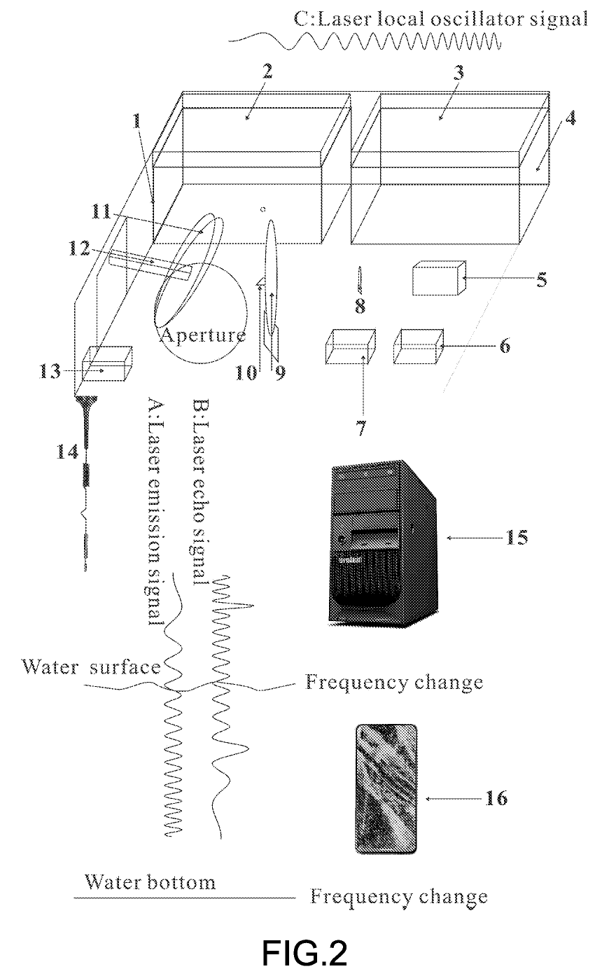

Components of the unmanned aerial vehicle-mounted continuous variable-frequency blue-green laser radar for water depth survey are explained with reference to FIG. 2, comprising components like a blue-green light variable-frequency laser, a laser power supply driver, an encoding motor, a reflective optical wedge, a reflector, a big lens, a small lens, a balanced light detection module, a high-speed laser acquisition processor, an IMU module, an RTK module, a 4G module, a controller, a 4G antenna, a server and a mobile phone terminal.

After receiving a signal sent by a controller, the blue-green light variable-frequency laser emits variable-frequency blue-green laser of 380-600 nm with a peak power of 400 mW, a pulse width of 10 μs, a divergence angle less than 0.2 mrad and a Gaussian distribution from a center to a periphery, and a part of optical signals are separated out of the blue-green light variable-frequency laser by a beam splitter, transmitted to a photomultiplier, and then a local oscillation laser signal is output. Meanwhile, a working state signal is emitted to the controller at a frequency of 30 Hz.

After receiving the signal sent by the controller, the laser power supply driver configures a power supply module according to a parameter of the laser to provide a stable direct-current power supply for the laser with a voltage of 24 V and a current of 150-320 mA. Meanwhile, a working state signal is emitted to the controller at a frequency of 30 Hz.

After receiving an initialization instruction of the controller, the encoding motor immediately returns to zero and calculates a rotation angle of the motor from a fixed position. The encoding motor is equipped with a 1000-wire optical-electricity encoder and a Hall sensor, wherein a voltage is 24V, a rotating speed is 3,000 r/min, a power is 64 W, a constant torque is 0.2 N·m and an output rotation angle precision is 0.1 degree. A working state signal is emitted to the controller at a frequency of 30 Hz.

The reflector forms an included angle of 45 degrees with the laser, and is made of a base material of silicon with a diameter of 3 mm, a thickness of 3 mm, a surface plated with gold and a reflectivity more than 99.99%. A middle of the reflector is fixed at a center position of the big lens through a triangular disc to reflect the laser beam to the reflective optical wedge.

The reflective optical wedge has a dynamic balance function, a center of the reflective optical wedge forms angles of 30 degrees and 75 degrees with an irradiated laser beam, and an included angle between a reflected laser beam and an upper part changes continuously between 30 degrees and 75 degrees when the reflective optical wedge is mounted on the motor to rotate, thus forming a circular track with a scanning angle of 45 degrees.

The big lens is actually a double-simple lens with positive optical power, a clear aperture of 60 mm, a focal length of 128 mm, and an interval of 106.7 mm from the small lens. The big lens comprises one doublet-cemented lens and one simple lens; the doublet-cemented lens comprises one convex lens and one concave lens; and the simple lens is a convex lens made of ZK7 glass with small dispersion.

The small lens is actually a doublet-cemented lens provided with negative optical power, a clear aperture of 10 mm and a focal length of -35.6 mm. The doublet-cemented lens comprises one flint glass convex lens in the front and one Burmese glass concave lens in the back.

The balanced light detection module has a spectral range of 380-1700 nm, a bandwidth of 3 dB, a response time less than 0.2 ns, a common mode rejection ratio more than 30 dB, and a voltage of 24 V. Meanwhile, data are sent to the high-speed laser acquisition processor at a frequency of 200 Hz and a working state signal is sent to the controller at a frequency of 30 Hz.

The high-speed laser acquisition processor is mainly used to acquire the local oscillation laser signal transmitted by the blue-green light variable-frequency laser and the laser echo signal detected by the balanced light detection module, perform convolution operation and fast Fourier transform on the two signals to obtain an echo frequency difference between the water surface and the water bottom, convert the frequency difference into a corresponding time difference, and obtain the water-depth slant distance with reference to a propagation speed of the laser in the water, substitute the water-depth slant distance into a rotation matrix together with the encoder angle of the motor, three attitude angles of the IMU and positioning information of the RTK, and convert the data into an actual water depth of the surveyed position, and transmit the actual water depth to the controller. Meanwhile, a working state signal is emitted to the controller at a frequency of 30 Hz.

The IMU module is mainly used to acquire a pitching angle, a roll angle and a yaw angle of a carried platform, wherein a resolution is 0.01 degree. Meanwhile, data and a working state signal are sent to the controller at a frequency of 200 Hz.

The RTK module is mainly used to acquire longitude and latitude information, wherein a horizontal precision is better than 0.01 m. Meanwhile, data and a working state signal are sent to the controller at a frequency of 200 Hz.

The 4G module supports dual communication functions of 4G DTU and radio communication (up to 50 km at most), automatically switches to radio communication when there is no 4G signal, sends an instruction forwarded by a server, and sends data and a working state signal back to the server.

The controller is used to initialize and control the blue-green light variable-frequency laser, the laser power supply driver, the high-speed laser acquisition processor, the encoding motor, the balanced light detection module, the IMU module, the RTK module and the 4G module to obtain working states of these modules.

The 4G antenna is used to enhance a 4G signal and a radio signal, so that the signals are enhanced to be more than 3 dB.

The server has a fixed IP address, and both the 4G module and the mobile phone are connected with the server through the IP address, and then the server saves and forwards the data sent by the 4G module and the mobile phone terminal to realize communication between the 4G module and the mobile phone terminal, realize remote control of the unmanned aerial vehicle-mounted continuous variable-frequency blue-green laser radar for water depth survey by the mobile phone, and send back water depth survey data of the unmanned aerial vehicle-mounted continuous variable-frequency blue-green laser radar for water depth survey to the mobile phone in real time.

The mobile phone terminal supports 4G and an external wireless communication module (the wireless communication module is paired with the 4G module of the laser radar in radio communication), and is responsible for connecting the server, and sending an instruction to the unmanned aerial vehicle-mounted continuous variable-frequency blue-green laser radar for water depth survey in real time through the server, wherein water depth survey data of a target position sent back is displayed and saved on the mobile phone.

When the radar is mounted on the unmanned aerial vehicle, a working process of the unmanned aerial vehicle-mounted continuous variable-frequency blue-green laser radar for water depth survey is as follows:

a user starts the unmanned aerial vehicle-mounted continuous variable-frequency blue-green laser radar for water depth survey at the mobile phone terminal, and starts a signal server and the 4G module to send data to the controller, the controller starts all components of the laser radar, and meanwhile, acquires working state signals of all the components, and sends the working state signals back to the mobile phone terminal and display the working state signals. The controller gives start instructions to the blue-green light variable-frequency laser, the laser power supply driver, the high-speed laser acquisition processor, the encoding motor, the balanced light detection module, the IMU module, the RTK module and the 4G module to work. Meanwhile, the working states of the blue-green light variable-frequency laser, the laser power supply driver, the high-speed laser acquisition processor, the encoding motor, the balanced light detection module, the IMU module, the RTK module and the 4G module are acquired, sent back to the mobile phone terminal and displayed.

The laser power supply driver supplies power to the blue-green light variable-frequency laser, emits one beam of local oscillation laser signal to the high-speed laser acquisition processor, and also emits one beam of laser to the water surface. Meanwhile, the state is sent to the controller.

The encoding motor rotates according to a set parameter, and starts scanning work to acquire as much water domain data as possible. Meanwhile, the rotation angle and the working state are sent to the high-speed laser acquisition processor and the controller respectively.

The balanced light detection module detects the laser echo signal received, and transmits the laser echo signal to the high-speed laser acquisition processor. Meanwhile, the working state is sent to the controller.

The IMU module collects the pitching angle, the roll angle and the yaw angle of the platform and sends the angles to the high-speed laser acquisition processor. Meanwhile, the working state is sent to the controller.

The RTK module acquires the longitude and latitude information, and sends the information to the high-speed laser acquisition processor. Meanwhile, the working state is sent to the controller.

The 4G module is connected with the mobile phone terminal through a 4G signal and the server, and the latter is connected with the mobile phone terminal through a radio signal. The instruction forwarded by the server are sent to the unmanned aerial vehicle-mounted continuous variable-frequency blue-green laser radar for water depth survey, and the data and the working state signals are sent back to the mobile phone terminal.

The high-speed laser acquisition processor acquires the local oscillation signal and the laser echo signal of the laser, performs convolution, Fourier transform, frequency difference and time difference operation, calculates the water-depth slant distance, reads the rotation angle of the motor, the data of the three attitude angles and the positioning data, substitutes the data into the rotation matrix, obtains the actual water depth of the target position, sends the data to the controller, and then sends the data back to the mobile phone for display through the 4G module (and the server), and saves the data to the mobile phone.

Steps (2) to (8) are repeated until all echo signals of water depth in a target area are detected.

The user turns off the unmanned aerial vehicle-mounted continuous variable-frequency blue-green laser radar for water depth survey at the mobile phone terminal, and a turn-off signal is sent to the controller through the 4G module to turn off the blue-green light variable-frequency laser, the laser power supply driver, the high-speed laser acquisition processor, the encoding motor, the balanced light detection module, the IMU module, the RTK module and the 4G module in turn.

The above embodiments are only used to illustrate the present disclosure, but are not intended to limit the present disclosure. Those of ordinary skills in the art can make various changes and modifications without departing from the spirit and scope of the present disclosure. Therefore, all equivalent technical solutions also belong to the scope of the present disclosure, and the patent protection scope of the present disclosure should be defined by the claims.

### Reference Signs List

1 - blue-green light variable-frequency laser; 2 - laser power supply driver; 3 - controller; 4 - high-speed laser acquisition processor; 5 - PMT detector; 6 - IMU module; 7 - RTK module; 8 - big lens of reflector; 9 - small lens; 10 - reflective optical wedge; 11 - motor; 12 - 4G module; 13 - 4G antenna; 14 - server; and 15 - mobile phone terminal.

What is claimed is:

1. An unmanned aerial vehicle-mounted continuous variable-frequency blue-green laser radar for water depth survey, wherein the radar comprises the following steps when being used for water depth survey:
S1: emitting, by a blue-green light variable-frequency laser, two beams of continuous variable-frequency blue-green laser, wherein one beam is an A laser emission signal and the other beam is a C laser local oscillation signal; and forming a time-frequency diagram by corresponding a frequency domain with a time domain;
S2: generating, by the A laser emission signal, frequency shift after the A laser emission signal is reflected by a water surface, transmitting a water body and reaching a water bottom and being reflected again to generate frequency shift to form a B laser echo signal, and collecting, by a high-speed laser acquisition processor, the B laser echo signal;
S3: directly inputting the C laser local oscillation signal to the high-speed laser acquisition processor, and performing, by the processor, convolution operation on the C laser local oscillation signal and the B laser echo signal to generate a convolution laser echo signal in a spatial domain;
S4: converting the convolution laser echo signal in the spatial domain into a frequency domain through fast Fourier transform, generating an amplitude-frequency diagram, identifying frequency peaks corresponding to the water surface and the water bottom, and calculating a frequency difference △f between the two frequency peaks;
S5: generating a time-frequency difference diagram based on the time-frequency diagram and the amplitude-frequency diagram, converting the frequency difference △f into a time difference △t, and calculating a traveled distance of the laser in the water with reference to a transmission speed of the laser in the water to obtain a water-depth slant distance; and
S6: converting the water-depth slant distance into an actual water depth of a surveyed position through a rotation matrix according to a rotation angle of an encoding motor, three attitude angles of a POS and positioning information of an RTK module.

2. The unmanned aerial vehicle-mounted continuous variable-frequency blue-green laser radar for water depth survey according to claim 1, wherein the radar comprises a blue-green light variable-frequency laser, a laser power supply driver, an encoding motor, a reflective optical wedge, a reflector, a big lens, a small lens, a balanced light detection module, a high-speed laser acquisition processor, an IMU module, an RTK module, a 4G module, a controller, a 4G antenna, a server and a mobile phone terminal;
wherein, the blue-green light variable-frequency laser emits continuous variable-frequency blue-green laser of 380-600 nm with a peak power of 400 mW, a pulse width of 10 μs, a divergence angle less than 0.2 mrad and a Gaussian distribution from a center to a periphery according to a received signal sent by the controller, and a part of optical signals are separated by a beam splitter as local oscillation laser signals, and the blue-green light variable-frequency laser emits a working state signal to the controller at a frequency of 30 Hz;
after receiving the signal sent by the controller, the laser power supply driver provides a direct-current power supply of 24 V for the blue-green light variable-frequency laser according to a parameter of the blue-green light variable-frequency laser, wherein a current range is 150-320 mA, and the laser power supply driver emits a working state signal to the controller at a frequency of 30 Hz;
the encoding motor is equipped with a 1000-wire optical-electricity encoder and a Hall sensor, wherein a voltage is 24 V, a rotating speed is 3,000 r/min, a power is 64 W, a constant torque is 0.2 N·m and an output rotation angle precision is 0.1 degree; the encoding motor emits a working state signal to the controller at a frequency of 30 Hz; and after receiving an initialization instruction of the controller, the encoding motor immediately returns to zero and calculates the rotation angle of the encoding motor from a fixed position;
the reflector forms an included angle of 45 degrees with the laser, and is made of a base material of silicon with a diameter of 3 mm, a thickness of 3 mm, a surface plated with gold and a reflectivity more than 99.99%, and a middle of the reflector is fixed at a center position of the big lens through a triangular disc to reflect the laser beam to the reflective optical wedge;
the reflective optical wedge has a dynamic balance function, a center of the reflective optical wedge forms angles of 30 degrees and 75 degrees with an irradiated laser beam, and an included angle between a reflected laser beam and an upper part changes continuously between 30 degrees and 75 degrees when the reflective optical wedge is mounted on the motor to rotate, thus forming a circular track with a scanning angle of 45 degrees;
the big lens is a double-simple lens with positive optical power, a clear aperture of 60 mm, a focal length of 128 mm, and an interval of 106.7 mm from the small lens; the big lens comprises one doublet-cemented lens and one simple lens; the doublet-cemented lens of the big lens comprises one convex lens and one concave lens; and the simple lens is a convex lens made of ZK7 glass with small dispersion;
the small lens is a doublet-cemented lens with negative optical power, a clear aperture of 10 mm and a focal length of -35.6 mm; and the doublet-cemented lens of the small lens comprises one flint glass convex lens in the front and one Burmese glass concave lens in the back;
the balanced light detection module has a spectral range of 380-1700 nm, a bandwidth of 3 dB, a response time less than 0.2 ns, a common mode rejection ratio more than 30 dB, and a voltage of 24 V; and the balanced light detection module sends data to the high-speed laser acquisition processor at a frequency of 200 Hz and sends a working state signal to the controller at a frequency of 30 Hz;
the high-speed laser acquisition processor is used to acquire the local oscillation laser signal transmitted by the blue-green light variable-frequency laser and the laser echo signal detected by the balanced light detection module, perform convolution operation and fast Fourier transform on the two signals to obtain an echo frequency difference between the water surface and the water bottom, convert the frequency difference into a corresponding time difference, and obtain the water-depth slant distance with reference to a propagation speed of the laser in the water, substitute the water-depth slant distance into a rotation matrix together with an encoder angle of the motor, three attitude angles of the IMU and positioning information of the RTK, and convert the data into an actual water depth of the surveyed position, and transmit the actual water depth to the controller, and the high-speed laser acquisition processor emits a working state signal to the controller at a frequency of 30 Hz;
the IMU module is used to acquire a pitching angle, a roll angle and a yaw angle of a carried platform, wherein a resolution is 0.01 degree, and the IMU module sends data and a working state signal to the controller at a frequency of 200 Hz;
the RTK module is used to acquire longitude and latitude information, wherein a horizontal precision is better than 0.01 m, and the RTK module sends data and a working state signal to the controller at a frequency of 200 Hz;
the 4G module supports dual communication functions of 4G DTU and radio communication, automatically switches to radio communication when there is no 4G signal, sends an instruction forwarded by a server, and sends data and a working state signal back to the server;
the controller is used to initialize and control the blue-green light variable-frequency laser, the laser power supply driver, the high-speed laser acquisition processor, the encoding motor, the balanced light detection module, the IMU module, the RTK module and the 4G module to obtain working states of these modules;
the 4G antenna is used to enhance a 4G signal and a radio signal, so that the signals are enhanced to be more than 3 dB;
the server has a fixed IP address, and both the 4G module and the mobile phone are connected with the server through the IP address, and then the server saves and forwards the data sent by the 4G module and the mobile phone terminal to realize communication between the 4G module and the mobile phone terminal, realize remote control of the unmanned aerial vehicle-mounted continuous variable-frequency blue-green laser radar for water depth survey by the mobile phone, and send back water depth survey data of the unmanned aerial vehicle-mounted continuous variable-frequency blue-green laser radar for water depth survey to the mobile phone in real time; and
the mobile phone terminal supports 4G and an external wireless communication module, the wireless communication module is paired with the 4G module of the laser radar in radio communication, and is responsible for connecting the server, and sending an instruction to the unmanned aerial vehicle-mounted continuous variable-frequency blue-green laser radar for water depth survey in real time through the server, wherein water depth survey data of a target position sent back is displayed and saved on the mobile phone.

3. The unmanned aerial vehicle-mounted continuous variable-frequency blue-green laser radar for water depth survey according to claim 1, wherein a working process of mounting the radar on the unmanned aerial vehicle for water depth survey is as follows:
(1) a user starts the unmanned aerial vehicle-mounted continuous variable-frequency blue-green laser radar for water depth survey at the mobile phone terminal, and starts a signal server and the 4G module to send data to the controller, the controller starts all components of the laser radar, and meanwhile, acquires working state signals of all the components, and sends the working state signals back to the mobile phone terminal and display the working state signals;
wherein the controller gives start instructions to the blue-green light variable-frequency laser, the laser power supply driver, the high-speed laser acquisition processor, the encoding motor, the balanced light detection module, the IMU module, the RTK module and the 4G module to work, and meanwhile, acquires the working states of the blue-green light variable-frequency laser, the laser power supply driver, the high-speed laser acquisition processor, the encoding motor, the balanced light detection module, the IMU module, the RTK module and the 4G module, and sends the working states back to the mobile phone terminal and displays the working states;
(2) the laser power supply driver supplies power to the blue-green light variable-frequency laser, emits one beam of local oscillation laser signal to the high-speed laser acquisition processor, and also emits one beam of laser to the water surface, and meanwhile, emits a state to the controller;
(3) the encoding motor rotates according to a set parameter, and starts scanning work to acquire as much water domain data as possible, and meanwhile, sends the rotation angle and the working state to the high-speed laser acquisition processor and the controller respectively;
(4) the balanced light detection module detects the laser echo signal received, transmits the laser echo signal to the high-speed laser acquisition processor, and meanwhile, sends the working state signal to the controller;
(5) the IMU module collects the pitching angle, the roll angle and the yaw angle of the platform and sends the angles to the high-speed laser acquisition processor, and meanwhile, sends the working state to the controller;
(6) the RTK module acquires the longitude and latitude information, and sends the information to the high-speed laser acquisition processor, and meanwhile, sends the working state to the controller;
(7) the 4G module is connected with the mobile phone terminal through a 4G signal and the server, and the latter is connected with the mobile phone terminal through a radio signal, sends the instruction forwarded by the server to the unmanned aerial vehicle-mounted continuous variable-frequency blue-green laser radar for water depth survey, and sends back the data and the working state signals to the mobile phone terminal;
(8) the high-speed laser acquisition processor acquires the local oscillation signal and the laser echo signal of the laser, performs convolution, fast Fourier transform, frequency difference and time difference operation, calculates the water-depth slant distance, reads the rotation angle of the motor, the data of the three attitude angles and the positioning data, substitutes the data into the rotation matrix, obtains the actual water depth of the target position, sends the data to the controller, and then sends the data back to the mobile phone for display through the 4G module and the server, and saves the data to the mobile phone;
(9) steps (2) to (8) are repeated until all echo signals of water depth in a target area are detected; and
(10) the user turns off the unmanned aerial vehicle-mounted continuous variable-frequency blue-green laser radar for water depth survey at the mobile phone terminal, and a turn-off signal is sent to the controller through the 4G module to turn off the blue-green light variable-frequency laser, the laser power supply driver, the high-speed laser acquisition processor, the encoding motor, the balanced light detection module, the IMU module, the RTK module and the 4G module in turn.
